(19) United States
(12) Patent Application Publication
(10) Pub. No.: US 2017/0214725 A1
(43) Pub. Date: Jul. 27, 2017

(54) Communication Method, Communication System, and Storage Medium Storing Communication Program

(71) Applicant: Brother Kogyo Kabushiki Kaisha, Nagoya-shi (JP)

(72) Inventors: Yasuhiro Kudo, Ichinomiya-shi (JP); Takashi Matsushita, Nagoya-shi (JP)

(21) Appl. No.: 15/415,304

(22) Filed: Jan. 25, 2017

(30) Foreign Application Priority Data
Jan. 25, 2016 (JP) 2016-011633

(51) Int. Cl. H04L 29/06

(52) U.S. Cl. CPC H04L 65/403; H04L 67/42; H04L 65/607

(57) ABSTRACT

A communication method includes: receiving a plurality of first media data transmitted from a plurality of first conference clients by communication of a first method; transmitting the received plurality of first media data to a virtual conference client by the first method; receiving the plurality of first media data transmitted from the conference server, by the first method; mixing the received plurality of first media data to generate mixing data; transmitting the generated mixing data to a second conference client by communication of a second method; receiving second media data from the second conference client by the second method; transmitting the received second media data to the conference server by the first method; receiving the second media data transmitted from the virtual conference client, by the first method; and transmitting the received second media data to the plurality of first conference clients by the first method.

### CROSS REFERENCE TO RELATED APPLICATIONS

This application claims priority from Japanese Patent Application No. 2016-011633 filed Jan. 25, 2016. The entire content of the priority application is incorporated herein by reference.

### TECHNICAL FIELD

This disclosure relates to a communication method, a communication system, and a storage medium storing a communication program for realizing a teleconference by performing communication through a network.

### BACKGROUND

A system for performing a teleconference among a plurality of communication apparatuses connected to a network is known. A known system has a Universal Bridge (UB), a plurality of Media Relay Endpoints (MRE), and a plurality of Legacy Endpoints (LEP). The UB receives, decodes, and combines a plurality of streams transmitted by the MRE. Hereinafter, the plurality of combined streams is referred to as “combined stream”. The UB encodes the combined stream based on a compression standard used in the LEP. The UB transmits the encoded combined stream to the LEP.

### SUMMARY

According to one aspect, this specification discloses a communication method. The communication method includes: receiving, by a conference server, a plurality of first media data transmitted from a plurality of first conference clients by communication of a first method, the plurality of first conference clients being configured to perform a teleconference through the conference server by communication of the first method; transmitting, by the conference server, the received plurality of first media data to a virtual conference client by communication of the first method; receiving, by the virtual conference client, the plurality of first media data transmitted from the conference server, by communication of the first method; mixing, by the virtual conference client, the received plurality of first media data to generate mixing data; transmitting, by the virtual conference client, the generated mixing data to a second conference client by communication of a second method, the second conference client being configured to perform a teleconference by communication of the second method, the second method being different from the first method; receiving, by the virtual conference client, second media data from the second conference client by communication of the second method; transmitting, by the virtual conference client, the received second media data to the conference server by communication of the first method; receiving, by the conference server, the second media data transmitted from the virtual conference client, by communication of the first method; and transmitting, by the conference server, the received second media data to the plurality of first conference clients by communication of the first method.

According to another aspect, this specification also discloses a communication system including a first server and a second server. The first server includes: a first network interface; a first hardware processor; and a first memory storing instructions, the instructions, when executed by the first hardware processor, causing the first server to perform: receiving a plurality of first media data through the first network interface, the plurality of first media data being transmitted from a plurality of first conference clients by communication of a first method, the plurality of first media data being encoded by a first codec, the plurality of first conference clients being configured to perform a teleconference through the first server by communication of the first method; and transmitting the received plurality of first media data to the second server through the first network interface by communication of the first method. The second server is physically different from the first server. The second server includes: a second network interface; a second hardware processor; and a second memory storing instructions, the instructions, when executed by the second hardware processor, causing the second server to perform: receiving the plurality of first media data transmitted from the first server, through the second network interface, by communication of the first method; decoding the received plurality of first media data by the first codec; mixing the decoded plurality of first media data to generate mixing data; encoding the generated mixing data by a second codec; transmitting the mixing data encoded by the second codec, to a second conference client, through the second network interface by communication of a second method, the second conference client being configured to perform a teleconference by communication of a second method, the second method being different from the first method; receiving second media data encoded by the second codec, from the second conference client, through the second network interface by communication of the second method; decoding the received second media data by the second codec; encoding the decoded second media data by the first codec without mixing with the plurality of first media data; and transmitting the second media data encoded by the first codec, to the first server, through the second network interface by communication of the first method. The first server is configured to perform: receiving the second media data transmitted from the second server, through the first network interface, by communication of the first method; and transmitting the received second media data to the plurality of first conference clients through the first network interface by communication of the first method.

According to still another aspect, this specification also discloses a non-transitory computer-readable storage medium storing a communication program. The communication program is executable on a computer of a server. The communication program causes, when executed, the server to perform operations comprising: an operation of, when a conference server receives, by communication of a first method, a plurality of first media data that is transmitted from a plurality of first conference clients by communication of the first method and that is encoded by a first codec and the conference server transmits the received plurality of first media data by communication of the first method, receiving the plurality of first media data from the conference server by communication of the first method, the plurality of first conference clients being configured to perform a teleconference through the conference server by communication of the first method; an operation of decoding the received plurality of first media data by the first codec; an operation of mixing the decoded plurality of first media data to generate mixing data; an operation of encoding the generated mixing data by a second codec; an operation of transmitting the mixing data encoded by the second codec, to a second conference client, by communication of a second method, the second conference client being configured to perform communication of the second method, the second method being different from the first method; an operation of receiving second media data encoded by the second codec, from the second conference client, by communication of the second method; an operation of decoding the received second media data by the second codec; an operation of encoding the decoded second media data by the first codec without mixing with the plurality of first media data; and an operation of transmitting the second media data encoded by the first codec, to the conference server, by communication of the first method.

### BRIEF DESCRIPTION OF THE DRAWINGS

Embodiments in accordance with this disclosure will be described in detail with reference to the following figures wherein:

FIG. 1 is a diagram showing an overview of a communication system 1 and an electrical configuration of a server 25;

FIG. 2 is a block diagram showing an electrical configuration of a conference client 20;

FIG. 3 is a functional block diagram of the conference client 20;

FIG. 4 is a functional diagram showing a virtual conference client 28;

FIG. 5 is a diagram showing a first starting sequence;

FIG. 6 is a diagram showing a second starting sequence;

FIG. 7 is a diagram showing a first ending sequence;

FIG. 8 is a diagram showing a second ending sequence;

FIG. 9 is a diagram showing a third ending sequence;

FIG. 10 is a diagram showing a reconnecting sequence; and

FIG. 11 is a diagram showing an overview of a communication system 1A.

### DETAILED DESCRIPTION

There is a demand to realize a teleconference by performing communication among a plurality of communication apparatuses having different communication methods. If the above-mentioned known technique is applied to this demand, a UB that performs decoding, combining, and encoding is needed. For this reason, it is desirable to realize communication between the MRE and the LEP through an existing conference server or the like, without requiring the UB.

An aspect of this disclosure provides, for example, a communication method for realizing a teleconference by performing communication among communication apparatuses having different communication methods, while using an existing system configuration.

### Overview of Communication System 1

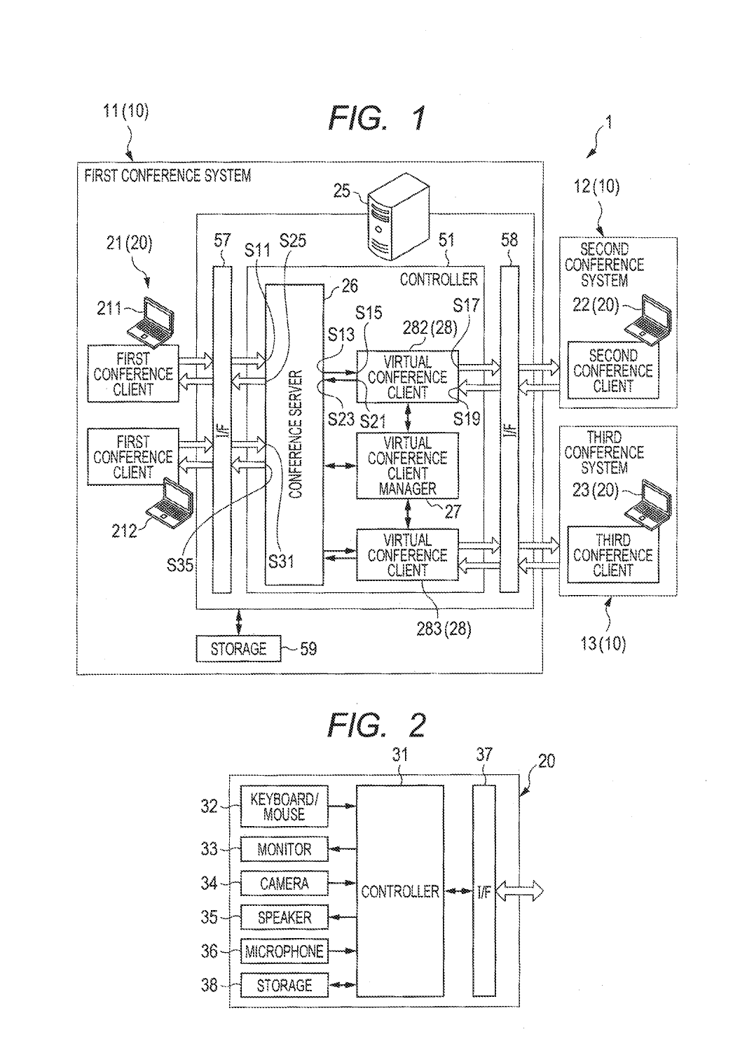

A communication system 1 will be described while referring to FIG. 1. The communication system 1 includes a plurality of conference systems 10 different from one another. Each conference system 10 includes at least a conference client 20. Each user of the conference client 20 which is included in the same conference system 10 can perform a Web conference with each other by joining a virtual conference room. Each conference client 20 is configured by installing a program of a Web conference application to a known Personal Computer (PC). Hereinafter, performing a WEB conference, which is an example of a teleconference, among each user of the conference client 20 is rephrased as “a Web conference is performed among the conference clients 20”.

This embodiment illustrates a case in which the communication system 1 includes three conference systems 10 (a first conference system 11, a second conference system 12, and a third conference system 13). The first conference system 11 includes a server 25 and first conference clients 211, 212. The server 25, which is a physical server, performs a Web conference between the first conference clients 211 and 212. The server 25 is a Multi-point Control Unit (MCU) or is configured by installing a dedicated application program to a known server. The second conference system 12 includes a second conference client 22 and another second conference client (not shown). The third conference system 13 includes a third conference client 23 and another third conference client (not shown). The conference systems 10 are connected to one another through a network (not shown), and the server 25 and the conference clients 20 included in each conference system 10 are also connected to one another through a network (not shown).

The communication method used in the system for a Web conference in each conference system 10 is different from the communication method used in another conference system 10. The communication method here means a communication protocol that runs in an application layer. The specific examples of the communication method include H323, SIP, H245, a unique protocol, and so on. Specifically, in the first conference system 11, the first conference clients 211, 212 (hereinafter, collectively referred to as “first conference client 21”) perform communication of a first method with the server 25. This enables a Web conference to be performed between the first conference clients 21. In the second conference system 12, the second conference client 22 performs communication of a second method with another second conference client directly or through a server. This enables a Web conference to be performed between the second conference client 22 and another second conference client. In the third conference system 13, the third conference client 23 performs communication of a third method with another third conference client directly or through a server. This enables a Web conference to be performed between the third conference client 23 and another third conference client. The first, second, and third methods are communication methods that are different from one another.

In order to perform a Web conference among the conference clients 20 that use different communication methods, the server 25 executes at least the following processing (1) to (3). Hereinafter, out of programs installed in the server 25, an executable unit of a program corresponding to each processing below is referred to as “process”.

(1) Processing for executing a Web conference between the first conference clients 21 by performing communication of the first method with the first conference clients 21

(2) Processing for executing a Web conference between the first conference client 21 and the second conference client 22 by performing communication of the second method with the second conference clients 22, or processing for executing a Web conference between the first conference client 21 and the third conference client 23 by performing communication of the third method with the third conference clients 23

(3) Processing for starting up a process corresponding to (2)

The process corresponding to (1) performs communication of the first method with the first conference clients 21 in the first conference system 11 to enable a Web conference among each first conference client 21. Hereinafter, this process is referred to as “conference server 26”. An application for starting up the conference server 26 is referred to as “conference server application”. That is, the conference server 26 is executed by the conference server application that is executed in the server 25. The conference server 26 realizes a function of a conference server in a Web conference, that is, a function of transferring media data that is transmitted and received between the plurality of first conference clients 21 when the plurality of first conference clients 21 performs a Web conference.

As the process for executing the processing (2), virtual conference clients 282, 283 are executed in the server 25. An application for starting up the virtual conference clients 282, 283 is referred to as “virtual conference client application”. That is, the virtual conference clients 282, 283 are executed by the virtual conference client application that is executed in the server 25. The virtual conference client 282 performs communication of the second method with the second conference client 22, thereby enabling a Web conference between the first conference client 21 and the second conference client 22 through the conference server 26. The virtual conference client 282 executes processing equivalent to the processing of the second conference client 22. Hence, the second conference client 22 performs communication with the virtual conference client 282 by using the same communication method as the case in which the second conference client 22 performs communication with another second conference client included in the second conference system 12. The virtual conference client 282 is different from the second conference client 22 in that the virtual conference client 282 also performs communication of the first method with the conference server 26. That is, the virtual conference client 282 performs communication of the first method with the conference server 26, and also performs communication of the second method with the second conference client 22. As a result, communication is performed between the second conference client 22 and the conference server 26 through the virtual conference client 282.

The virtual conference client 283 performs communication of the third method with the third conference client 23, thereby enabling a Web conference between the first conference client 21 and the third conference client 23 through the conference server 26. The virtual conference client 283 executes processing equivalent to the processing of the third conference client 23. Hence, the third conference client 23 performs communication with the virtual conference client 283 by using the same communication method as the case in which the third conference client 23 performs communication with another third conference client included in the third conference system 13. The virtual conference client 283 is different from the third conference client 23 in that the virtual conference client 283 also performs communication of the first method with the conference server 26. That is, the virtual conference client 283 performs communication of the first method with the conference server 26, and also performs communication of the third method with the third conference client 23. As a result, communication is performed between the third conference client 23 and the conference server 26 through the virtual conference client 283.

Here, data communication between the conference server 26 and the virtual conference client 282, 283 corresponds to data exchange between processes, and is different from actual communication through a network. In this application, the idea that “data is transmitted and received” includes data exchange between processes in the server 25 as well as actual communication through a network. The virtual conference clients 282, 283 are collectively referred to as “virtual conference client 28”. The same protocol used for communication through a network may be used for communication between the conference server 26 and the virtual conference client 28. Further, the virtual conference client 28 is also different from the conference client 20 in that the virtual conference client 28 does not have hardware devices described later (keyboard/mouse 32, monitor 33, camera 34, speaker 35, and microphone 36, see FIG. 2).

As the process for executing the processing (3), a virtual conference client manager 27 is executed in the server 25. The virtual conference client manager 27 starts up the virtual conference client 28 in response to an instruction from the conference server 26.

As described above, the server 25 executes mutual communication among the first conference client 21, the second conference client 22, and the third conference client 23 by using the above-mentioned processes (the conference server 26, the virtual conference client manager 27, and the virtual conference client 28). This enables the server 25 to execute a Web conference among the first conference client 21, the second conference client 22, and the third conference client 23.

### Electrical Configuration of Conference Client 20

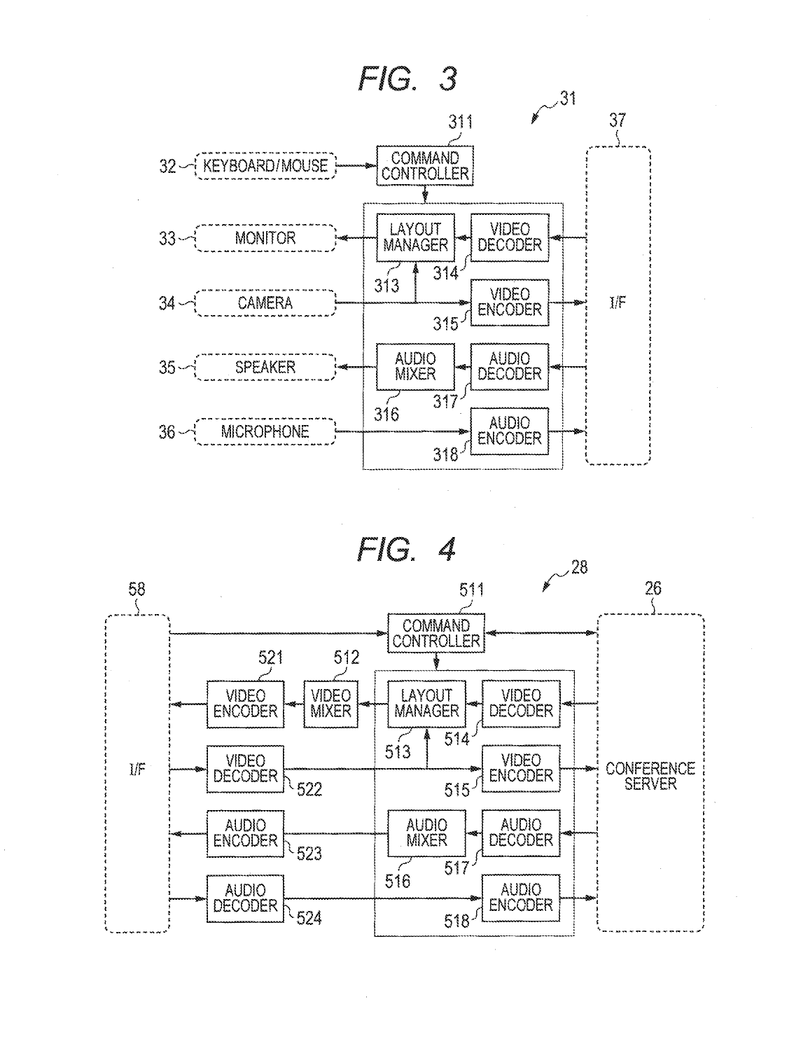

The electrical configuration of the conference client 20 will be described while referring to FIG. 2. The conference client 20 has a controller 31. The controller 31 performs overall controls of the conference client 20. The controller 31 includes a hardware processor (e.g., a CPU), a ROM, and a RAM (not shown). Further, in a case where a part of each function described later (a video decoder 314, a video encoder 315, an audio decoder 317, and an audio encoder 318, see FIG. 3) is achieved by hardware, the controller 31 may include an electronic circuit (an ASIC and so on) for realizing that function. The controller 31 is electrically connected to the keyboard/mouse 32, the monitor 33, the camera 34, the speaker 35, the microphone 36, an interface 37, and a storage 38.

The keyboard/mouse 32 outputs, to the controller 31, an operation signal corresponding to an operation. The camera 34 shoots a video image and outputs data of the shot video image (referred to as “video data”) to the controller 31. The monitor 33 displays a video image corresponding to video data outputted from the controller 31. The microphone 36 collects sound and outputs data of the collected sound (referred to as “audio data”) to the controller 31. The speaker 35 outputs sound corresponding to audio data outputted from the controller 31. The interface 37 is an interface element (for example, a LAN card) for enabling the conference client 20 to connect to a network. The controller 31 performs transmission/reception of data with the server 25 and other conference client 20 through the interface 37.

The storage 38 is a non-transitory computer-readable storage medium such as a hard disk drive. The storage 38 stores a program and an OS. For example, the storage 38 may be another non-transitory storage medium such as a flash memory and/or a ROM. The non-transitory storage medium may be a storage medium configured to store information, irrespective of a duration of storing the information. The non-transitory storage medium may be a non-transitory storage medium that does not include a transitory storage medium (for example, transmission signals).

FIG. 3 shows each function and data flows realized by software processing executed by the controller 31. The controller 31 realizes functions corresponding to each of a command controller 311, a layout manager 313, the video decoder 314, the video encoder 315, the audio mixer 316, the audio decoder 317, and the audio encoder 318. As described above, the video decoder 314, the video encoder 315, the audio decoder 317, and the audio encoder 318 may be realized by hardware processing by an electronic circuit included in the controller 31.

The video decoder 314 decodes video data received through the interface 37 (see FIG. 2). The video encoder 315 encodes video data outputted from the camera 34 (see FIG. 2). The audio decoder 317 decodes audio data received through the interface 37 (see FIG. 2). The audio encoder 318 encodes audio data outputted from the microphone 36 (see FIG. 2).

In the first conference client 21, video data and audio data are encoded or decoded by a first codec. In the second conference client 22, video data and audio data are encoded or decoded by a second codec. In the third conference client 23, video data and audio data are encoded or decoded by a third codec. The first codec, the second codec, and the third codec indicate algorithms for performing encoding and decoding bidirectionally. The first codec, the second codec, and the third codec are different from one another.

The layout manager 313 arranges video images based on video data so that the video images can be displayed on the monitor 33 (see FIG. 2). The video data including the video image arranged by the layout manager 313 is outputted to the monitor 33. The command controller 311 sets a rule of arranging the video image to the layout manager 313, based on an operation signal outputted from the keyboard/mouse 32 (see FIG. 2). The audio mixer 316 mixes sounds based on audio data and combines the sounds into one sound. The audio data of the sounds combined by the audio mixer 316 is outputted to the speaker 35 (see FIG. 2).

### Electrical Configuration of the Server 25

The electrical configuration of the server 25 will be described while referring to FIG. 1. The server 35 has a controller 51. The controller 51 manages the entire control by the server 25. The controller 51 includes a hardware processor (e.g., a CPU), a ROM, and a RAM (not shown). In a case where a part of each function described later (video decoders 514, 522, video encoders 515, 521, audio decoders 517, 524, and audio encoders 518, 523; see FIG. 4) is achieved by hardware, the controller 51 may include an electronic circuit (an ASIC and so on) for achieving that function. The controller 51 is electrically connected to interfaces 57, 58 and a storage 59.

The interfaces 57, 58 are interface elements (for example, a LAN card) for enabling the server 25 to connect to a network. The controller 51 performs transmission/reception of data with a plurality of the conference clients 20 through the interfaces 57, 58. In FIG. 1, the interface 57 for connecting to the first conference client 21 through a network and the interface 58 for connecting to the second conference client 22 and the third conference client 23 through a network are distinguished. A common hardware may be used as the interfaces 57, 58.

The storage 59 is a non-transitory computer-readable storage medium such as a hard disk drive. The storage 59 stores a program and an OS. Each process described above (the conference server 26, the virtual conference client manager 27, and the virtual conference client 28) corresponds to a part of the program stored in the storage 59, the part of the program being executed by the controller 51. For example, the storage 59 may be another non-transitory storage medium such as a flash memory and/or a ROM. The non-transitory storage medium may be a storage medium configured to store information, irrespective of a duration of storing the information. The non-transitory storage medium may be a non-transitory storage medium that does not include a transitory storage medium (for example, transmission signals).

FIG. 4 shows each function realized by software processing and data flows when the virtual conference client 28 is executed by the controller 51. The controller 51 realizes functions corresponding to each of a command controller 511, a video mixer 512, a layout manager 513, the video decoders 514, 522, the video encoders 515, 521, an audio mixer 516, the audio decoders 517, 524, and the audio encoders 518, 523. As described above, the video decoders 514, 522, the video encoders 515, 521, the audio decoders 517, 524, and the audio encoders 518, 523 may be realized by hardware processing by an electronic circuit included in the controller 51.

The command controller 511, the layout manager 513, the video decoder 514, the video encoder 515, the audio mixer 516, the audio decoder 517, and the audio encoder 518 correspond to the command controller 311, the layout manager 313, the video decoder 314, the video encoder 315, the audio mixer 316, the audio decoder 317, and the audio encoder 318, respectively, out of a plurality of functions realized by the controller 31 of the conference client 20 (see FIG. 3). One of the first codec, the second codec, and the third codec is used as a codec.

The functions of the virtual conference client 28 realized by the controller 51 are different from the functions realized by the controller 31 of the conference client 20 (see FIG. 3) in that the functions of the virtual conference client 28 further include the video encoder 521, the video mixer 512, the video decoder 522, the audio encoder 523, and the audio decoder 524. The video encoder 521 and the video mixer 512 virtually realize a function corresponding to the monitor 33 in the conference client 20. The video decoder 522 virtually realizes a function corresponding to the camera 34 in the conference client 20. The audio encoder 523 virtually realizes a function corresponding to the speaker 35 in the conference client 20. The audio decoder 524 virtually realizes a function corresponding to the microphone 36 in the conference client 20. That is, in the virtual conference client 28, the functions of hardware devices in the conference client 20 (the keyboard/mouse 32, the monitor 33, the camera 34, the speaker 35, and the microphone 36; see FIG. 2) are replaced by the video encoder 521, the video mixer 512, the video decoder 522, the audio encoder 523, and the audio decoder 524.

### Communication at Web Conference between the First Conference Clients 21

The overview of communication will be described for a case where a Web conference is performed between the first conference clients 21. The controller 31 of the first conference client 21 acquires video data outputted from the camera 34. As shown in FIG. 3, the controller 31 encodes the acquired video data by using the video encoder 315. The video data is encoded by the first codec. The controller 31 transmits the encoded video data, through the interface 37, to the conference server 26 executed by the controller 51 of the server 25 (hereinafter, simply referred to as “conference server 26”) by the first method.

As shown in FIG. 1, the conference server 26 receives video data transmitted from the first conference client 211 through the interface 57 (S11). The conference server 26 transmits the received video data to the first conference client 212 through the interface 57 by the first method (S35).

As shown in the FIG. 3, the controller 31 of the first conference client 212 receives video data transmitted from the conference server 26 through the interface 37. The controller 31 decodes the received video data by using the video decoder 314. The video data is decoded by the first codec. The controller 31 arranges a video image based on the decoded video data and a video image based on video data outputted from the camera 34, by using the layout manager 313. Specifically, a video image shot by the camera 34 of the first conference client 211 and a video image shot by the camera 34 of the first conference client 212 are arranged side by side, for example. The controller 31 outputs video data of the arranged video image to the monitor 33. The monitor 33 displays the arranged video image base on the video data outputted from the controller 31.

The controller 31 of the first conference client 211 acquires audio data outputted from the microphone 36. As shown in FIG. 3, the controller 31 encodes acquired audio data by using the audio encoder 318. The audio data is encoded by the first codec. The controller 31 transmits the encoded audio data to the conference server 26 through the interface 37 by the first method. As shown in the FIG. 1, the conference server 26 receives the audio data transmitted from the first conference client 211 through the interface 57 (S11). The conference server 26 transmits the received audio data to the first conference client 212 through the interface 57 by the first method (S35).

The controller 31 of the first conference client 212 receives audio data transmitted from the conference server 26 through the interface 37. As shown in FIG. 3, the controller 31 decodes the received audio data by using the audio decoder 317. The audio data is decoded by the first codec. The controller 31 mixes sound based on the decoded audio data by using the audio mixer 316. In this case, audio data of sound including sound collected by the microphone 36 of the first conference client 211 is generated. The controller 31 outputs the generated audio data to the speaker 35. The speaker 35 outputs sound based on the audio data outputted from the controller 31.

Although the details are omitted, processing similar to the above-described processing is executed when video data and audio data are transmitted from the first conference client 212 and are received by the first conference client 211, and a video image and sound are outputted in the first conference client 211 (S25, S31).

### Communication at Web Conference between the First Conference Client 21 and the Second Conference Client 22

The overview of communication will be described for a case where a Web conference is performed between the first conference client 21 and the second conference client 22. Descriptions will be omitted or simplified for the same contents as communication in the case where a Web conference is performed between the first conference clients 21.

As shown in FIG. 1, the conference server 26 receives video data transmitted from the first conference client 211, through the interface 57, by the first method (S11). The conference server 26 transmits the received video data to the first conference client 212 through the interface 57 by the first method (S35). Similarly, the conference server 26 receives video data transmitted from the first conference client 212, through the interface 57, by the first method (S31). The conference server 26 transmits the received video data to the first conference client 211 through the interface 57 by the first method (S25).

The conference server 26 transmits video data received from each of the first conference clients 211, 212, to the virtual conference client 282 that is executed by the controller 51 (hereinafter referred to as “virtual conference client 282”), by the first method (S13). In this way, the conference server 26 transmits video data by the common communication method (i.e., the first method) regardless of whether the transmission destination of the video data is the first conference client 21 or the virtual conference client 282 (S15). The virtual conference client 282 receives the video data by the first method (S15).

As shown in FIG. 4, the virtual conference client 282 decodes each of video data transmitted from the first conference client 211 and video data transmitted from the first conference client 212, by using the video decoder 514. The video data is decoded by the first codec. The virtual conference client 282 arranges video images based on the two decoded video data by using the layout manager 513. The virtual conference client 282 mixes the two arranged video images by using the video mixer 512 and generates video image mixing data. The virtual conference client 282 encodes the generated video image mixing data by using the video encoder 521. The video image mixing data is encoded by the second codec. As shown in FIG. 1, the virtual conference client 282 transmits the encoded video image mixing data to the second conference client 22 through the interface 58 by the second method (S17).

In the above-described operation, in the virtual conference client 282, the function of the monitor 33 in the conference client 20 is replaced by the video encoder 521 and the video mixer 512. That is, the virtual conference client 282 outputs video data to a module of the video encoder 521 and the video mixer 512 by using the same method as the case of outputting video data to the monitor 33. Due to this processing, video image mixing data is generated by the video mixer 512, and the video image mixing data is encoded by the video encoder 521.

The controller 31 of the second conference client 22 receives the video image mixing data transmitted from the virtual conference client 282, through the interface 37, by the second method. In this way, the controller 31 receives the video image mixing data from the virtual conference client 282 by using the same communication method as the case where video data is received from another second conference client (the second method).

As shown in FIG. 3, the controller 31 of the second conference client 22 decodes the received video image mixing data by using the video decoder 314. The video image mixing data is decoded by the second codec. Here, the video image mixing data is encoded by the second codec in the virtual conference client 282. Hence, the controller 31 appropriately performs decoding of the video image mixing data by the second codec.

The controller 31 of the second conference client 22 arranges a video image based on the decoded video image mixing data and a video image based on video data outputted from the camera 34, by using the layout manager 313. For example, two video images shot by camera 34 of each of the first conference clients 211, 212 and a video image shot by the camera 34 of the second conference client 22 are arranged side by side. The controller 31 outputs video data of the arranged video images to the monitor 33. The monitor 33 displays the arranged video images based on the video data outputted from the controller 31.

The controller 31 of the second conference client 22 acquires video data outputted from the camera 34. The controller 31 encodes the acquired video data by using the video encoder 315. The video data is encoded by the second codec. The controller 31 transmits the encoded video data to the virtual conference client 282 through the interface 37 by the second method. As shown in FIG. 1, the virtual conference client 282 receives, through the interface 58, video data transmitted from the second conference client 22 (S19).

As shown in FIG. 4, the virtual conference client 282 decodes the received video data by using the video decoder 522. The video data is decoded by the second codec. In the virtual conference client 282, the function of the camera 34 in the conference client 20 is replaced by the video decoder 522. That is, the virtual conference client 282 acquires video data decoded by the video decoder 522, by using the same method as the case of acquiring video data outputted from the camera 34.

The virtual conference client 282 encodes the decoded video data by using the video encoder 515. The video data is encoded by the first codec. As shown in FIG. 1, the virtual conference client 282 transmits the encoded video data to the conference server 26 by the first method (S21).

The conference server 26 receives the video data transmitted from the virtual conference client 282 by the first method (S23). In this way, the conference server 26 receives video data from the virtual conference client 282 by using the same communication method as the case where video data is received from the first conference client 21 (the first method). The conference server 26 transmits the received video data to the first conference clients 211, 212 through the interface 57 by the first method (S25, S35).

The controller 31 of the first conference client 211 receives, through the interface 37, video data transmitted from each of the conference server 26 and the first conference client 212. The controller 31 decodes the received video data by using the video decoder 314. The video data is decoded by the first codec. Here, the video data is encoded by the first codec in the virtual conference client 282. Hence, the controller 31 appropriately performs decoding of video data by the first codec.

As shown in FIG. 3, the controller 31 of the first conference client 211 arranges a video image based on the decoded video data and a video image based on video data outputted from the camera 34, by using the layout manager 313. For example, two video images shot by the camera 34 of each of the first conference clients 211, 212 and a video image shot by the camera 34 of the second conference client 22 are arranged side by side. The controller 31 outputs video data of the arranged video images to the monitor 33. The monitor 33 displays the arranged video images based on video data outputted from the controller 31.

Although the details are omitted, in a case where video data transmitted from the conference server 26 is received by the first conference client 212, too, processing similar to the above is executed and a video image is displayed on the monitor 33.

In FIG. 4, the audio mixer 516, the audio decoders 517, 524 and the audio encoders 518, 523 that perform processing for audio data correspond to the video mixer 512, the video decoders 514, 522, and the video encoders 515, 521 that perform processing for video data, respectively. The details of communication processing corresponding to audio data are omitted. Hereinafter, video data and audio data are collectively referred to as “media data”. The video image mixing data and the audio data mixed by the audio mixer 516 are collectively referred to as “mixing data”.

Moreover, when a Web conference is performed between the first conference client 21 and the third conference client 23, substantially the same processing as the above-described processing by the virtual conference client 282 is executed by the virtual conference client 283. The processing of the virtual conference client 283 is different from the processing of the virtual conference client 282 in that the third codec is used instead of the second codec when media data is encoded or decoded.

### Communication Sequence when Starting Web Conference

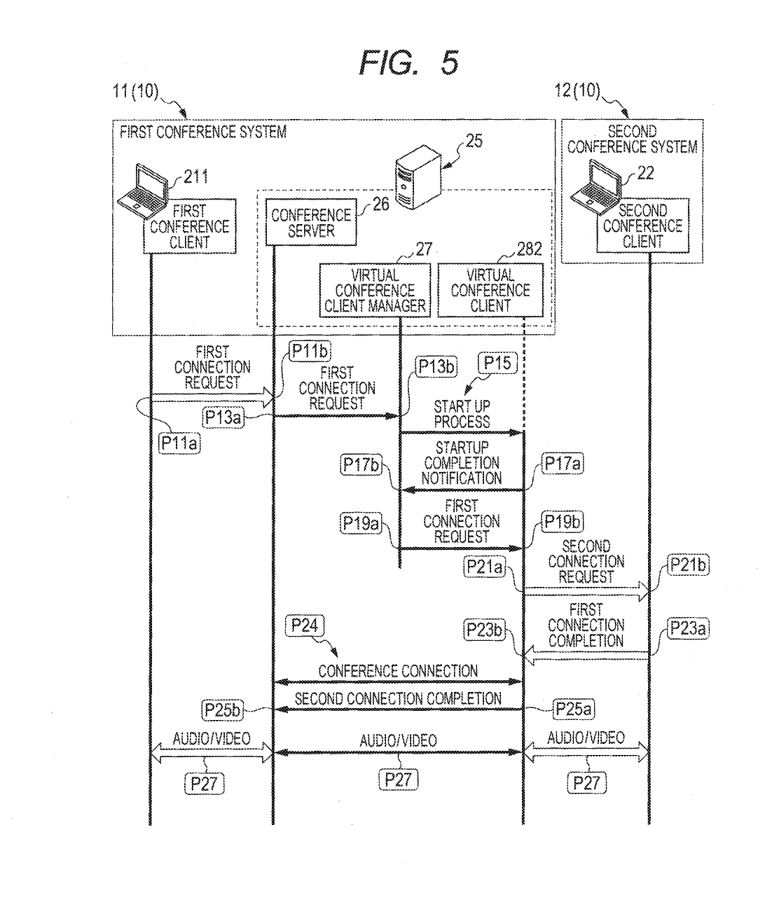

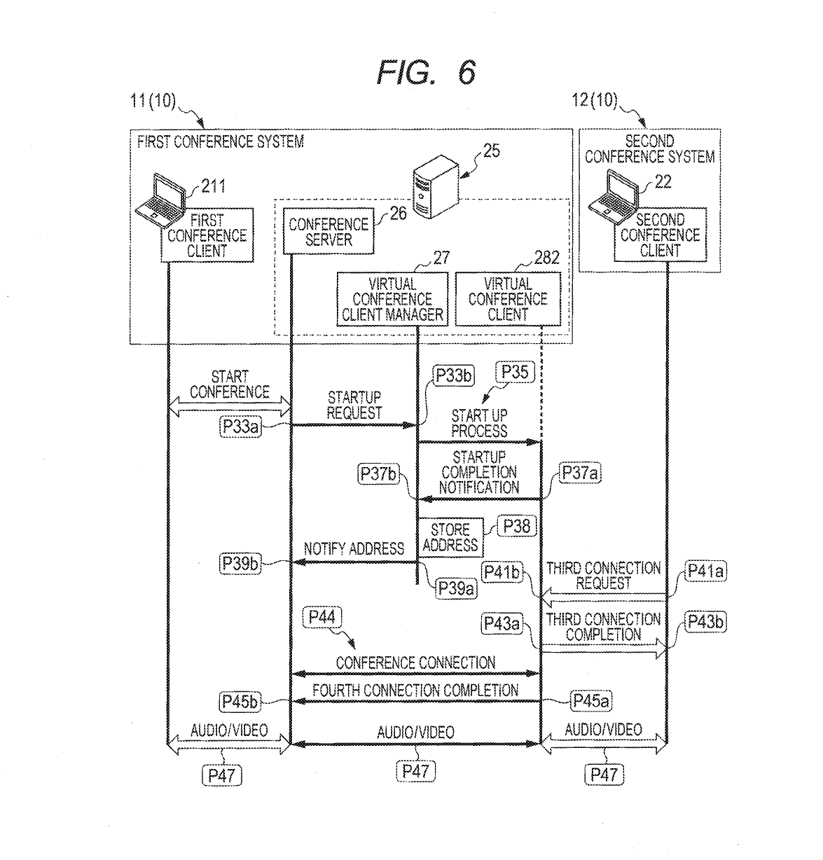

A communication procedure in a case where a Web conference is started between the first conference client 211 and the second conference client 22 (a first starting sequence (see FIG. 5) and a second starting sequence (see FIG. 6)) will be described while referring to FIGS. 5 and 6. It is assumed that a Web conference is already started between the first conference clients 21 in the first conference system 11. Further, it is assumed that, in the controller 51 of the server 25, the conference server 26 and the virtual conference client manager 27 are already started up and the virtual conference client 28 is not started up yet.

The following is an overview of a communication procedure in a case where a Web conference is started between the first conference clients 21. The user of each of the first conference clients 211, 212 performs a particular operation for using a virtual conference room (hereinafter, simply referred to as “conference room”). The particular operation is the same as an operation performed by a user in a case where a conference room is used in a known Web conference system. For example, the particular operation is an operation to select a URL that is notified preliminarily from the server 25 to the first conference clients 21. This URL includes, for example, a conference ID for identifying the conference room to join. In this case, communication between the first conference client 21 and the server 25 through a network is performed, and known processing for conference connection is executed. By performing the known processing for conference connection, a session is established between the first conference client 21 and the server 25, and a Web conference using the conference room is enabled. Hereinafter, conference connection for enabling a Web conference between the server 25 and the conference client 20 will be referred to as “first conference connection”. After completing the first conference connection, a Web conference using the conference room corresponding to the conference ID can be performed between the first conference clients 21.

### First Starting Sequence

The first starting sequence will be described while referring to FIG. 5. The user of the first conference client 211 inputs, through the keyboard/mouse 32, an instruction for requesting conference connection between the second conference client 22 in the second conference system 12 and the first conference client 211. The user also inputs address information of the second conference client 22 through the keyboard/mouse 32. A specific example of the address information includes the IP address of the second conference client 22.

The controller 31 of the first conference client 211 transmits, to the conference server 26, data that requests conference connection between the conference client 20 outside the first conference system 11 (e.g., the second conference client 22) and the first conference client 211 (referred to as “first connection request data”) (P11a). The first connection request data includes address information of the second conference client 22. The conference server 26 receives the first connection request data transmitted from the first conference client 211 by the first method (P11b).

The conference server 26 transmits the received first connection request data to the virtual conference client manager 27 executed by the controller 51 (hereinafter, simply referred to as “virtual conference client manager 27”) (P13a). The virtual conference client manager 27 receives the first connection request data transmitted from the conference server 26, by the first method (P13b). The virtual conference client manager 27 starts up the virtual conference client 282 (P15).

When the virtual conference client 282 is started up in response to receiving the first connection request data, the virtual conference client 282 transmits data that notifies that the startup is completed (referred to as “startup completion notification data) to the virtual conference client manager 27 (P17a). The virtual conference client manager 27 receives the startup completion notification data transmitted from the virtual conference client 282, by the first method (P17b).

The virtual conference client manager 27 transmits, to the virtual conference client 282, the first connection request data received from the conference server 26 (P19a). The virtual conference client 282 receives the first connection request data transmitted from the virtual conference client manager 27, by the first method (P19b).

The virtual conference client 282 acquires address information included in the received first connection request data. The virtual conference client 282 transmits data that requests conference connection between the virtual conference client 282 and the second conference client 22 (hereinafter, referred to as “second connection request data”) to the second conference client 22 identified by the acquired address information (P21a). The second conference client 22 receives the second connection request data by the second method (P21b).

In a case where the virtual conference client 282 and the second conference client 22 support a plurality of communication methods, the second method may be specified by the first conference client 211. For example, the first connection request data transmitted by the first conference client 211 in P11a may include information that specifies the second method. Alternatively, the virtual conference client 282 may automatically select the second method from among a plurality of communication methods. For example, in P21a, the virtual conference client 282 transmits the second connection request data to the second conference client 22 sequentially by using each of the plurality of communication methods. When a communication method supported by the second conference client 22 is used, the second conference client 22 can receive and recognize the second connection request data and transmits the first connection completion data to the virtual conference client 282 (P23a). The virtual conference client 282 may determine, as the second method, the communication method used when the first connection request data is received in P23b.

Communication is performed between the virtual conference client 282 and the second conference client 22 through the network, and known processing for conference connection is executed. Hereinafter, conference connection for enabling a Web conference between the virtual conference client 282 and the conference client 20 (e.g., the second conference client 22) will be referred to as “second conference connection”. The second conference client 22 transmits data that notifies completion of the second conference connection (referred to as “first connection completion data”) to the virtual conference client 282 (P23a). The virtual conference client 282 receives the first connection completion data transmitted from the second conference client 22, by the second method (P23b). In this way, a session is established between the virtual conference client 282 and the second conference client 22.

The processing of conference connection is executed between the conference server 26 and the virtual conference client 282 (P24). Hereinafter, conference connection for enabling a Web conference between the conference server 26 and the virtual conference client 28 will be referred to as “third conference connection”. Here, both of the conference server 26 and the virtual conference client 28 are processes executed by the controller 51 of the server 25. Thus, the processing of the third conference connection is executed between two processes (the conference server 26 and the virtual conference client 28), unlike the processing of the first conference connection and the second conference connection that are executed through a network.

After completing the third conference connection, the virtual conference client 282 transmits, to the conference server 26, data that notifies completion of the third conference connection (referred to as “second connection completion data”) (P25a). The conference server 26 receives the second connection completion data transmitted from the virtual conference client 282, by the first method (P25b). In this way, a session is established between the conference server 26 and the virtual conference client 282, and a Web conference using a conference room is enabled. The conference room that is used is the conference room that is being executed between the first conference clients 21.

After completing the third conference connection between the conference server 26 and the virtual conference client 282, the first conference client 21 and the second conference client 22 perform communication of media data through the conference server 26 and the virtual conference client 282 (P27). Thus, a Web conference using a common conference room is performed between the first conference client 21 and the second conference client 22.

### Second Starting Sequence

A second starting sequence will be described while referring to FIG. 6. The second starting sequence is different from the first starting sequence in that conference connection between the first conference client 211 and the second conference client 22 is requested by the second conference client 22. When a Web conference between the first conference clients 21 is started, the conference server 26 transmits data that requests startup of the virtual conference client 28 (referred to as “startup request data”) to the virtual conference client manager 27 (P33a). The virtual conference client manager 27 receives the startup request data transmitted from the conference server 26, by the first method (P33b).

The virtual conference client manager 27 starts up the virtual conference client 282 (P35). When the virtual conference client 282 is started up in response to receiving the startup request data, the virtual conference client 282 determines address information of the virtual conference client 282. The address information includes a port number that identifies the virtual conference client 282. Because the virtual conference client 282 is started up in association with a conference room that is being executed between the first conference clients 21, the port number can be regarded as information that identifies the conference room. Here, if the virtual conference client 282 and the second conference client 22 support a plurality of communication methods, a plurality of the virtual conference clients 282 may be started up in association with the plurality of communication methods. In this case, the port number of each of the plurality of the started virtual conference clients 282 is different from each other. The virtual conference client 282 transmits startup completion notification data to the virtual conference client manager 27 (P37a). The startup completion notification data includes address information of the virtual conference client 282. If the plurality of the virtual conference clients 282 is started up, a plurality of address information may be notified. The virtual conference client manager 27 receives the startup completion notification data transmitted from the virtual conference client 282, by the first method (P37b).

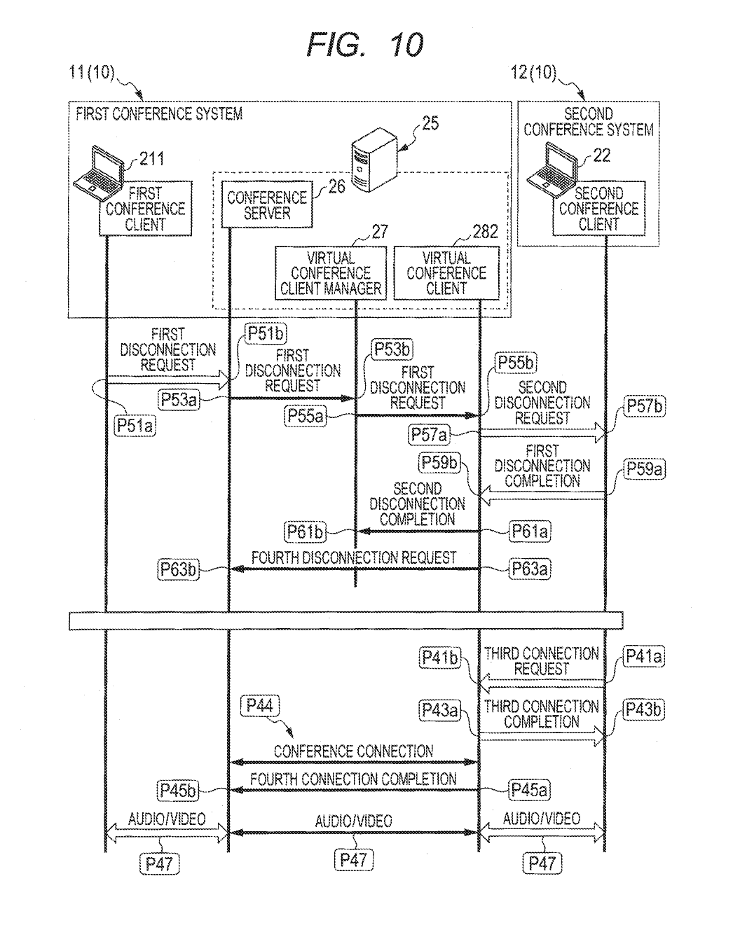

The virtual conference client manager 27 acquires the address information included in the received startup completion notification data. The virtual conference client manager 27 stores the acquired address information in the storage 59 (P38). Here, the address information stored in the storage 59 is used when conference connection is restarted between the first conference client 21 and the second conference client 22 in a reconnecting sequence described later (see FIG. 10). The details will be described later. The virtual conference client manager 27 transmits data that notifies the acquired address information (referred to as “address notification data”) to the conference server 26 (P39a). The conference server 26 receives the address notification data transmitted from the virtual conference client manager 27 by the first method (P39b).

The user of the second conference client 22 acquires the address information of the virtual conference client 282 by a particular method. The particular method is not limited, but, for example, the conference server 26 may notify the second conference client 22 about the address information of the virtual conference client 282 through e-mail or a particular Web site. The user of the second conference client 22 inputs, through the keyboard/mouse 32, an instruction that requests joining the conference room that is being executed in the first conference system 11. The user also inputs, through the keyboard/mouse 32, the address information included in the address notification data (P39b) received by the conference server 26.

The second conference client 22 transmits data that requests the second conference connection with the virtual conference client 282 having the inputted address information (referred to as “third connection request data”) to the virtual conference client 282 (P41a). The virtual conference client 282 receives the third connection request data transmitted by the second conference client 22, by the second method (P41b). Here, if a plurality of the virtual conference clients 282 is started up in association with a plurality of communication methods, the virtual conference client 282 corresponding to the port number having received the third connection request data is used in the subsequent processing. In other words, the communication method corresponding to the port number having received the third connection request data is selected as the communication method for performing communication with the second conference client 22 (the second method).

The processing of the second conference connection is executed between the virtual conference client 282 and the second conference client 22. The virtual conference client 282 transmits data that notifies completion of the second conference connection (referred to as “third connection completion data”) to the second conference client 22 (P43a). The second conference client 22 receives the third connection completion data transmitted from the virtual conference client 282, by the second method (P43b). In this way, a session is established between the virtual conference client 282 and the second conference client 22.

The processing of the third conference connection is executed between the conference server 26 and the virtual conference client 282 (P44). After completing the third conference connection, the virtual conference client 282 transmits data that notifies completion of the third conference connection (referred to as “fourth connection completion data”) to the conference server 26 (P45a). The conference server 26 receives the fourth connection completion data transmitted from the virtual conference client 282, by the first method (P45b). In this way, a session is established between the conference server 26 and the virtual conference client 282, and a Web conference using a conference room is enabled. The conference room that is used is the conference room that is identified by the port number included in the address information of the virtual conference client 282, in other words, the conference room that is being executed between the first conference clients 21.

After completing the third conference connection between the conference server 26 and the virtual conference client 282, the first conference client 21 and the second conference client 22 perform communication of media data through the conference server 26 and the virtual conference client 282 (P47). In this way, a Web conference using a common conference room is performed between the first conference client 21 and the second conference client 22.

### Communication Sequence at the Time of Ending Web Conference

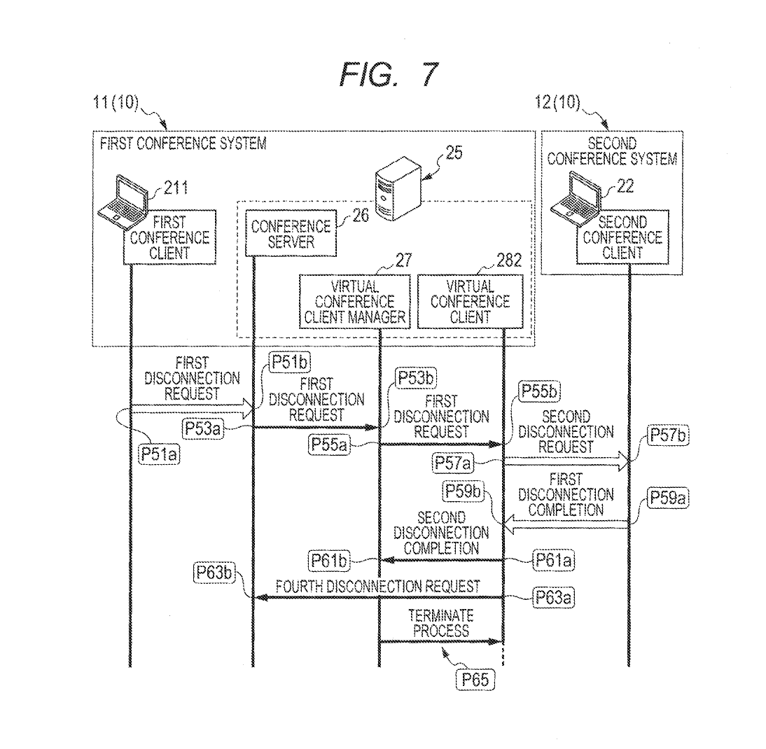

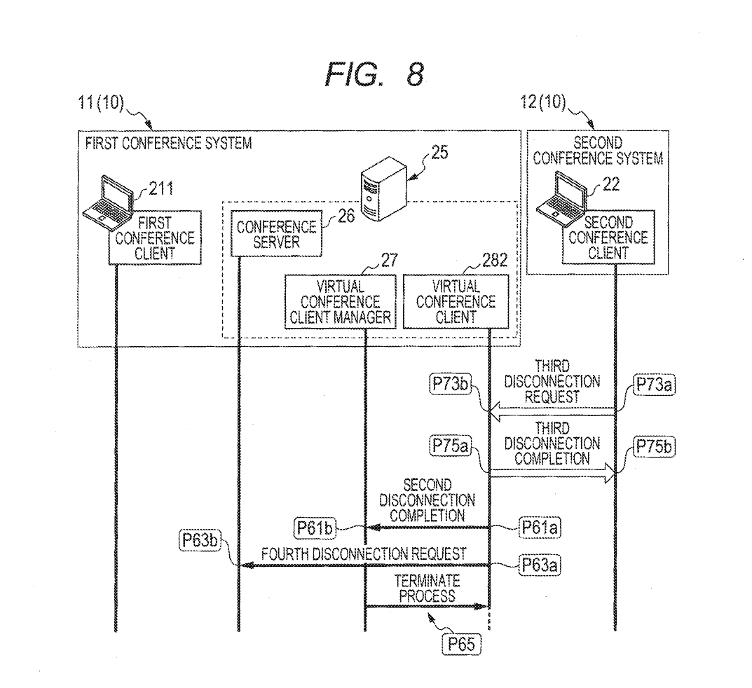

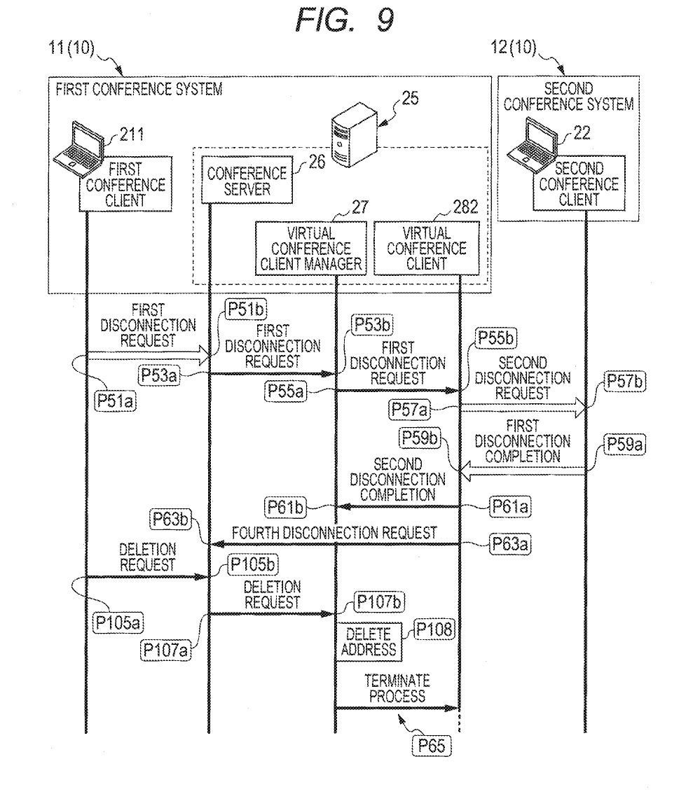

Ending sequences (a first ending sequence (see FIG. 7), a second ending sequence (see FIG. 8), and a third ending sequence (see FIG. 9)) will be described while referring to FIGS. 7 to 9. The ending sequences are communication procedures in which a Web conference is executed between the first conference client 21 and the second conference client 22, and the Web conference by the second conference client 22 is ended.

### First Ending Sequence

The first ending sequence will be described while referring to FIG. 7. The first ending sequence corresponds to a case in which a Web conference is started between the first conference client 21 and the second conference client 22 by the first starting sequence (see FIG. 5) and then the Web conference by the second conference client 22 is ended.

The user of the first conference client 211 inputs, through the keyboard/mouse 32, an instruction that requests disconnection of conference connection between the first conference client 211 and the second conference client 22. The first conference client 211 transmits data that requests disconnection of conference connection with the second conference client 22 (referred to as “first disconnection request data”) to the conference server 26 (P51a). The first disconnection request data includes address information of the second conference client 22. The conference server 26 receives the first disconnection request data transmitted from the first conference client 211, by the first method (P51b).

The conference server 26 transmits the received first disconnection request data to the virtual conference client manager 27 (P53a). The virtual conference client manager 27 receives the first disconnection request data transmitted from the conference server 26, by the first method (P53b). The virtual conference client manager 27 transmits the received first disconnection request data to the virtual conference client 282 (P55a). The virtual conference client 282 receives the first disconnection request data transmitted from the virtual conference client manager 27, by the first method (P55b).

The virtual conference client 282 transmits data that requests disconnection of the second conference connection between the virtual conference client 282 and the second conference client 22 (hereinafter referred to as “second disconnection request data”) to the second conference client 22 (P57a). The second conference client 22 receives the second disconnection request data transmitted from the virtual conference client 282, by the second method (P57b).

Known processing for disconnecting the second conference connection is executed between the virtual conference client 282 and the second conference client 22. The second conference client 22 transmits data that notifies completion of disconnection of the second conference connection (referred to as “first disconnection completion data”) to the virtual conference client 282 (P59a). The virtual conference client 282 receives the first disconnection completion data transmitted from the second conference client 22, by the second method (P59b). In this way, a session is disconnected between the virtual conference client 282 and the second conference client 22, and the second conference connection is disconnected. Due to this processing, the second conference client 22 exits the conference room, and the Web conference with the first conference client 211 is ended.

After the second conference connection between the virtual conference client 282 and the second conference client 22 is disconnected, the virtual conference client 282 transmits data that notifies completion of disconnection of the second conference connection (referred to as “second disconnection completion data”) to the virtual conference client manager 27 (P61a). The virtual conference client manager 27 receives the second disconnection completion data transmitted from the virtual conference client 282, by the first method (P61b).

After the second conference connection between the virtual conference client 282 and the second conference client 22 is disconnected, the virtual conference client 282 transmits data that requests disconnection of the third conference connection with the conference server 26 (referred to as “fourth disconnection request data”) to the conference server 26 (P63a). The conference server 26 receives the fourth disconnection request data transmitted from the virtual conference client 282, by the first method (P63b). Known processing for disconnecting the third conference connection is executed between the conference server 26 and the virtual conference client 282. Due to this processing, a session between the conference server 26 and the virtual conference client 282 is ended, and the third conference connection is disconnected.

When the second disconnection completion data transmitted from the virtual conference client 282 is received (P61b), the virtual conference client manager 27 terminates the virtual conference client 282 (P65).

### Second Ending Sequence

The second ending sequence will be described while referring to FIG. 8. The second ending sequence corresponds to a case in which a Web conference is started by the first starting sequence (see FIG. 5) and then the Web conference by the second conference client 22 is ended. The second ending sequence is different from the first ending sequence in that disconnection of the conference connection between the first conference client 211 and the second conference client 22 is requested by the second conference client 22. The same communication steps as those of the first ending sequence are designated by the same reference signs to avoid duplicating description.

The user of the second conference client 22 inputs, through the keyboard/mouse 32, an instruction that requests disconnection of the conference connection between the first conference client 21 and the second conference client 22. The second conference client 22 transmits data that requests disconnection of the conference connection with the first conference client 211 (referred to as “third disconnection request data”) to the virtual conference client 282 (P73a). The server 25 (e.g., the virtual conference client 282) receives the third disconnection request data transmitted from the second conference client 22, by the second method (P73b).

Known processing for disconnecting the second conference connection is executed between the virtual conference client 282 and the second conference client 22. The virtual conference client 282 transmits data that notifies completion of disconnection of the second conference connection (referred to as “third disconnection completion data”) to the second conference client 22 (P75a). The second conference client 22 receives the third disconnection completion data transmitted from the virtual conference client 282, by the second method (P75b). In this way, a session is ended between the virtual conference client 282 and the second conference client 22, and the second conference connection is disconnected. Due to this processing, the second conference client 22 exits the conference room, and the Web conference with the first conference client 211 is ended. The processing after this is the same as that of the first ending sequence.

### Third Ending Sequence

The third ending sequence will be described while referring to FIG. 9. The third ending sequence corresponds to a case in which a Web conference is started by the second starting sequence (see FIG. 6) and then the Web conference by the second conference client 22 is ended. The same communication steps as those of the first ending sequence (see FIG. 7) are designated by the same reference signs to avoid duplicating description.

After transmitting the first disconnection request data to the server 25 (e.g., the conference server 26) (P51a), the first conference client 211 transmits data that requests deletion of the address information stored in the storage 59 of the server 25 (referred to as a “deletion request data”) to the conference server 26 (P105a). The conference server 26 receives the deletion request data transmitted from the first conference client 211, by the first method (P105b).

The conference server 26 transmits the received deletion request data to the virtual conference client manager 27 (P1O7a). The virtual conference client manager 27 receives the deletion request data transmitted from the conference server 26, by the first method (P1O7b). The virtual conference client manager 27 deletes the address information (P38, see FIG. 6) stored in the storage 59 (P108). After the address information is deleted in response to receiving the deletion request data, the virtual conference client manager 27 terminates the virtual conference client 282 (P65).

### Communication Sequence at Reconnection

Descriptions will be provided while referring to FIG. 10 for a communication procedure (a reconnecting sequence) in which conference connection is restarted after conference connection is disconnected between the first conference client 21 and the second conference client 22. The reconnecting sequence corresponds to a communication procedure after a Web conference is started based on the second starting sequence (see FIG. 6). Hence, the address information determined at the startup of the virtual conference client 282 is stored in the storage 59 (P38, see FIG. 6). In the reconnecting sequence, the second conference connection and the third conference connection are disconnected based on a part of the procedures of the first ending sequence (see FIG. 7). Next, the second conference connection and the third conference connection are restarted based on a part of the procedures of the second starting sequence (see FIG. 6). The same communication steps as those of the first ending sequence and the second starting sequence are designated by the same reference signs to avoid or simplify duplicating description.

In FIG. 10, the communication procedure until the second conference connection and the third conference connection are disconnected is executed based on the first ending sequence (see FIG. 7) (P51a to P63b). The reconnecting sequence is different from the first ending sequence in that the virtual conference client 282 is not terminated even when the second disconnection completion data is received by the virtual conference client manager 27 (P61b). That is, the started virtual conference client 282 is maintained even after the second conference connection and the third conference connection are disconnected.

In the above-described state, the user of the second conference client 22 inputs, through the keyboard/mouse 32, an instruction that requests rejoining the conference room once exited. The user also inputs address information through the keyboard/mouse 32. The inputted address information is address information of the virtual conference client 282 for which the conference connection is disconnected once.

The second conference client 22 transmits data that requests the second conference connection with the virtual conference client 282 having the inputted address information (referred to as “third connection request data”) to the virtual conference client 282 (P41a). The virtual conference client 282 receives the third connection request data transmitted by the second conference client 22 (P41b).

When the address information included in the received third connection request data is identical to the address information stored in the storage 59, the virtual conference client 282 executes processing of the second conference connection with the second conference client 22. The virtual conference client 282 transmits the third connection completion data to the second conference client 22 (P43a). The second conference client 22 receives the third connection completion data transmitted from the virtual conference client 282 (P43b). Due to this processing, a session is established between the virtual conference client 282 and the second conference client 22, and the second conference connection is restarted. The processing of P45a and thereafter is the same as that of the second starting sequence.

### Main Effects of the Embodiment

As described above, the conference server 26 receives media data from the first conference client 21 (S11, S31) and transmits the media data to the virtual conference client 282 (S13). The virtual conference client 282 receives the media data transmitted from the conference server 26 (S15) and mixes the media data to generate mixing data. The virtual conference client 282 transmits the generated mixing data to the second conference client 22 (S17). Further, the virtual conference client 282 receives media data transmitted from the second conference client 22 (S19), and transmits the media data to the conference server 26 (S21). The conference server 26 receives the media data transmitted from the virtual conference client 282 (S23), and transmits the media data to the first conference client 21 (S25, S35).

In the above case, the conference server 26 performs communication with the virtual conference client 282 by a similar method to the case of performing communication with the conference client 20 that exists physically, thereby transferring media data between the first conference client 21 and the second conference client 22 and performing a Web conference between the first conference client 21 and the second conference client 22. Here, the virtual conference client 282 is a process that is started up by the virtual conference client manager 27, and the virtual conference client 282 does not exist physically. Thus, according to the above-described communication method, while using the existing server 25, a Web conference can be performed among the conference systems 10 having different communication methods.

The communication system 1 is advantageous in scalability when the number of the second conference clients 22 is increased. That is, even when the number of the second conference clients 22 is increased, such situation can be dealt with by adding the virtual conference client 28 that intermediates communication between each second conference client 22 and the plurality of the first conference clients 21, while keeping the conference server 26 as it is. Hence, it is unnecessary to add another conference server 26 in connection with an increase of the second conference clients 22.

The conference server 26 receives media data from the first conference client 21 and transmits the media data to the virtual conference client 282. The virtual conference client 282 decodes the received media data by the first codec, mixes the decoded media data to generate mixing data, and encodes the mixing data by the second codec. The virtual conference client 282 transmits the mixing data to the second conference client 22. And, the virtual conference client 282 receives media data from the second conference client 22, decodes the received media data by the second codec, encodes the decoded media data by the first codec, and transmits the encoded media data to the conference server 26. The conference server 26 receives the media data from the virtual conference client 282, and transmits the media data to the first conference client 21.

In this way, all of decoding, mixing, and encoding of media data are performed by the virtual conference client 282, and it is not performed by the conference server 26. Thus, even when the processing load is increased by each processing of encoding, decoding, and mixing or when a processing delay occurs, this does not tend to affect controls of a Web conference by the conference server 26. Hence, according to the above-described communication method, the conference server 26 appropriately performs controls of a Web conference among the conference clients 20, and the virtual conference client 28 executes each processing of encoding, decoding, and mixing of media data. Further, even when the virtual conference client 28 is added due to an increase of the number of the second conference clients 22 and the processing load of encoding, decoding, and mixing is increased, this increase of the processing load does not tend to affect controls of a Web conference by the conference server 26. Thus, according to the above-described communication method, the virtual conference client 28 can be added while keeping the conference server 26 as it is, which secures high scalability.

In the first starting sequence (see FIG. 5), the virtual conference client 282 receives the first connection request data transmitted from the virtual conference client manager 27 (P19b). In response to receiving the first connection request data, the virtual conference client 282 transmits the second connection request data to the second conference client 22 that is identified by address information included in the first connection request data (P21a). The virtual conference client 282 receives the first connection completion data transmitted from the second conference client 22 in response to transmitting the second connection request data (P23b). In response to receiving the first connection completion data, the virtual conference client 282 executes processing of the third conference connection with the conference server 26 (P24). In this case, in response to receiving the first connection request data transmitted from the virtual conference client manager 27 (P19b), the virtual conference client 282 identifies the second conference client 22 and performs the second conference connection with the second conference client 22. Further, the virtual conference client 282 performs the third conference connection with the conference server 26 after performing the second conference connection with the second conference client 22, thereby enabling communication between the first conference client 21 and the second conference client 22 and performing a Web conference.

In the first starting sequence (see FIG. 5), the virtual conference client manager 27 receives the first connection request data from the conference server 26 (P13b). In response to receiving the first connection request data, the virtual conference client manager 27 starts up the virtual conference client 282 (P15). The virtual conference client manager 27 transmits the received first connection request data to the virtual conference client (P19a). In this way, the virtual conference client manager 27 starts up the virtual conference client 282 (P15) in response to receiving the first connection request data (P13b). Thus, the virtual conference client manager 27 starts up the virtual conference client 282 at appropriate timing.

In the second starting sequence (see FIG. 6), the second conference client 22 transmits the third connection request data including the address information of the virtual conference client 282 (P41a). The virtual conference client 282 receives the third connection request data (P41b). In response to receiving the third connection request data, the virtual conference client 282 performs the third conference connection with the conference server 26 (P44, P45a, P45b). In this case, in response to receiving the third connection request data (P41b), the virtual conference client 282 performs the second conference connection with the second conference client 22 and performs the third conference connection with the conference server 26 (P43a, P43b, P44, P45a, P45b). Hence, according to the second starting sequence, the virtual conference client 282 enables communication between the first conference client 21 and the second conference client 22 and performs a Web conference at the timing when the second conference connection is performed with the second conference client 22.

In the first ending sequence (see FIG. 7), the first conference client 211 transmits, to the conference server 26, the first disconnection request data that requests disconnection of connection with the second conference client 22 (P51a). The conference server 26 receives the first disconnection request data (P51b), and transmits the first disconnection request data to the virtual conference client manager 27 (P53a). The virtual conference client manager 27 receives the first disconnection request data (P53b), and transmits the first disconnection request data to the virtual conference client 282 (P55a). The virtual conference client 282 receives the first disconnection request data (P55b), and transmits the second disconnection request data to the second conference client 22 (P57a). In response to receiving the first disconnection completion data from the second conference client 22 (P59b), the virtual conference client 282 disconnects the third conference connection with the conference server 26 (P63a, P63b). After the third conference connection between the virtual conference client 282 and the conference server 26 is disconnected, the virtual conference client manager 27 terminates the virtual conference client 282 (P65). In this way, in response to a request from the first conference client 21, the virtual conference client 282 disconnects the second conference connection with the second conference client 22 (P59a, P59b) and also disconnects the third conference connection between the virtual conference client 282 and the conference server 26 (P63a, P63b). Further, the virtual conference client manager 27 terminates the virtual conference client 282 for which the second conference connection and the third conference connection are disconnected, thereby suppressing maintaining the virtual conference client 28 that is not used in a Web conference.

In the first ending sequence (see FIG. 7), in response to receiving the first disconnection completion data from the second conference client 22 (P59b), the virtual conference client 282 transmits the second disconnection completion data to the virtual conference client manager 27 (P61a). In response to receiving the second disconnection completion data (P61b), the virtual conference client 27 terminates the virtual conference client 282 (P65). In this case, the virtual conference client manager 27 terminates the virtual conference client 282 appropriately, when the second conference connection between the second conference client 22 and the virtual conference client 282 and the third conference connection between the conference server 26 and the virtual conference client 282 are disconnected.

In the second ending sequence (see FIG. 8), the virtual conference client 282 receives, from the second conference client 22, the third disconnection request data that requests disconnection of connection with the first conference client 21 (P73b). In response to receiving the third disconnection request data, the virtual conference client 282 transmits the second disconnection completion data to the virtual conference client manager 27 (P61a). In response to transmitting the second disconnection completion data (P61a), the virtual conference client 282 disconnects the third conference connection with the conference server 26 (P63a, P63b). In response to receiving the second disconnection completion data (P61b), the virtual conference client manager 27 terminates the virtual conference client 282 (P65). In this way, in response to a request from the second conference client 22, the virtual conference client 282 disconnects the second conference connection with the second conference client 22 (P75a, P75b) and disconnects the third conference connection between the virtual conference client 282 and the conference server 26 (P63a, P63b). Further, the virtual conference client manager 27 terminates the virtual conference client 282 for which the second conference connection and the third conference connection are disconnected, thereby suppressing maintaining the virtual conference client 28 that is not used in a Web conference.

### Modifications

While the disclosure has been described in detail with reference to the above aspects thereof, it would be apparent to those skilled in the art that various changes and modifications may be made therein without departing from the scope of the claims.

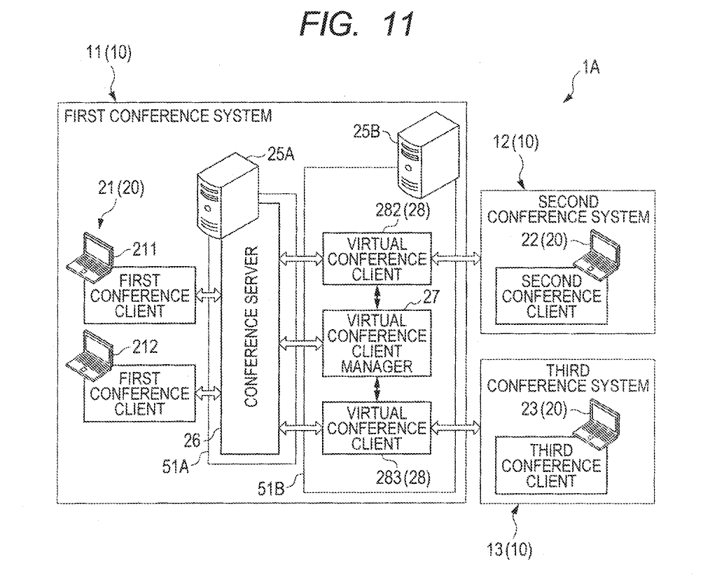

A communication system 1A according to a modification of this disclosure will be described while referring to FIG. 11. The communication system 1A is different from the communication system 1 of the above-described embodiment in that the first conference system 11 includes a first server 25A and a second server 25B. The first server 25A performs the function of a conference server in a Web conference, that is, the function of transferring media data that is transmitted and received between a plurality of first conference clients 21 when the plurality of first conference clients 21 performs a Web conference. The second server 25B acts as, for example, a proxy server that is provided between the first conference system 11 and the second and third conference systems 12, 13.

The first server 25A includes a controller 51A. The second server 25B includes a controller 51B. Both the controller 51A and the controller 51B include configurations identical to those of the controller 51 of the server 25. The controller 51A of the first server 25A executes the conference server 26 out of the plurality of processes in the above-described embodiment. On the other hand, the controller 51B of the second server 25B executes the virtual conference client manager 27 and the virtual conference client 28 out of the plurality of processes in the above-described embodiment. Although each of the first server 25A and the second server 25B includes network interface elements corresponding to the interfaces 57, 58 in the server 25 of FIG. 1, these configurations are omitted in FIG. 11 for simplification.

The overview of communication in a case where a Web conference is performed between the first conference client 21 and the second conference client 22 in the communication system 1A will be described. Media data transmitted from the first conference client 211 is received by the conference server 26 that is executed by the controller 51A of the first server 25A (hereinafter, referred to as “conference server 26 of the first server 25A”). The conference server 26 of the first server 25A transmits the received media data to the first conference client 212. Similarly, media data transmitted from the first conference client 212 is received by the conference server 26 of the first server 25A. The conference server 26 transmits the received media data to the first conference client 211 by the first method.

The conference server 26 of the first server 25A transmits media data received from each of the first conference clients 211, 212 to the virtual conference client 282 executed by the controller 51B of the second server 25B (hereinafter, referred to as “virtual conference client 282 of the second server 25B”). The virtual conference client 282 of the second server 25B receives the media data by the first method.

The virtual conference client 282 of the second server 25B decodes each media data transmitted from the first conference clients 211, 212 by the first codec. The virtual conference client 282 of the second server 25B mixes the decoded media data to generate mixing data. The virtual conference client 282 of the second server 25B encodes the generated mixing data. The mixing data is encoded by the second codec. The virtual conference client 282 of the second server 25B transmits the encoded mixing data to the second conference client 22 by the second method.

The controller 31 of the second conference client 22 receives the mixing data transmitted from the virtual conference client 282. The controller 31 decodes the received mixing data by the second codec. A video image base on the decoded mixing data is displayed on the monitor 33. Sound based on the decoded mixing data is outputted from the speaker 35.

The controller 31 of the second conference client 22 encodes media data acquired from the camera 34 and the microphone 36 by the second codec. The controller 31 transmits the encoded media data to the virtual conference client 282 of the second server 25B by the second method.

The virtual conference client 282 of the second server 25 receives the media data. The virtual conference client 282 of the second server 25B decodes the received media data by the second codec. The virtual conference client 282 of the second server 25B encodes the decoded media data by the first codec. The virtual conference client 282 of the second server 25B transmits the encoded media data to the conference server 26 of the first server 25A by the first method.

The conference server 26 of the first server 25A receives the media data. The conference server 26 of the first server 25A transmits the received media data to the first conference client 21 by the first method.

The controller 31 of the first conference client 21 receives the media data that is transmitted from each of the conference server 26 of the first server 25A and the other first conference client 21. The controller 31 decodes the received media data by the first codec. A video image based on the decoded mixing data is displayed on the monitor 33. Sound based on the decoded mixing data is outputted from the speaker 35.

As described above, in this modification, the conference server 26 and the virtual conference client 28 are executed by the controllers of physically different servers (the first server 25A and the second server 25B). Thus, even when the processing load of the virtual conference client 28 of the second server 25B is increased by each processing of encoding, decoding, and mixing or when a processing delay occurs, this does not tend to affect controls of a Web conference by the conference server 26 of the first server 25A. Hence, according to the above-described communication method of this modification, the first server 25A appropriately performs controls of a Web conference among the conference clients 20, and the second server 25B executes each processing of encoding, decoding, and mixing of media data.

Further, the communication system 1A is advantageous in scalability when the number of the second conference clients 22 is increased, which is similar to the communication system 1. That is, even when the number of the second conference clients 22 is increased, such situation can be dealt with by adding the virtual conference client 28 in the controller 51B of the second server 25B. Here, the controller 51A of the first server 25A may keep the conference server 26 as it is. Hence, it is unnecessary to add another first server 25A due to an increase of the second conference clients 22. Thus, even when the processing load of encoding, decoding, and mixing is increased in a case where the virtual conference client 28 is added due to an increase of the number of the second conference clients 22, this does not tend to affect controls of a Web conference by the conference server 26 executed by the controller 51A of the first server 25A. Thus, according to the above-described communication method, the virtual conference client 28 can be added in the controller 51B of the second server 25B while, in the first server 25A, the controller 51A keeps the conference server 26 as it is, which secures high scalability.

### Other Modifications

In the first starting sequence (see FIG. 5), the user of the first conference client 211 may input, through the keyboard/mouse 32, an instruction that requests conference connection between the second and third conference clients 22, 23 and the first conference client 211. In this case, the controller 31 of the first conference client 211 may transmit, to the conference server 26, two first connection request data including one first connection request data having address information of the second conference client 22 and the other first connection request data having address information of the third conference client 23 (P11a). When the conference server 26 receives the two first connection request data (P11b), the conference server 26 may transmit the two received first connection request data to the virtual conference client manager 27 (P13a). When the virtual conference client manager 27 receives the two first connection request data (P13b), the virtual conference client manager 27 may start up the virtual conference client 282 corresponding to the second conference client 22 and the virtual conference client 283 corresponding to the third conference client 23 in response to each first connection request data (P15). Due to this processing, a Web conference can be performed among the first conference client 21, the second conference client 22, and the third conference client 23.

In the above-described modification, when an instruction that requests conference connection with a plurality of the conference clients 20 is inputted by the user of the first conference client 211, the first conference client 211 may transmit one first connection request data including all address information of each conference client 20. When the virtual conference client manager 27 receives the first connection request data including a plurality of address information, the virtual conference client manager 27 may start up a plurality of virtual conference clients 28 corresponding to the plurality of address information.

In the above-described embodiment, the first codec and the second codec may be common. In this case, the processing of encoding and decoding in the virtual conference client 28 is unnecessary. Accordingly, when the virtual conference client 28 receives media data transmitted from the conference server 26 (S15), the virtual conference client 28 may mix the received media data as it is to generate mixing data and transmit the mixing data to the second conference client 22 as it is. Further, when the virtual conference client 28 receives media data transmitted from the second conference client 22 (S19), the virtual conference client 28 transmits the received media data to the conference server 26 as it is.

In the first starting sequence (see FIG. 5), when the virtual conference client 282 receives the first connection request data transmitted from the virtual conference client manager 27 (P19b), the virtual conference client 282 transmits the second connection request data to the second conference client 22 that is identified by the address information included in the first connection request data (P21a). However, the conference server 26 may transmit the first connection request data to the virtual conference client 282. The virtual conference client 282 may receive the first connection request data directly from the conference server 26, not through the virtual conference client manager 27.

In the first starting sequence (see FIG. 5), in response to receiving the first connection request data from the conference server 26 (P13b), the virtual conference client manager 27 starts up the virtual conference client 282 (P15). However, the virtual conference client 282 may be running all the time. Further, in the first to third ending sequences (see FIGS. 7 to 9), the virtual conference client need not be terminated. In these cases, the virtual conference client manager 27 need not be executed in the server 25.

In the second starting sequence (see FIG. 6), the second conference client 22 transmits the third connection request data including the address information of the virtual conference client 28 (P41a). The virtual conference client 282 receives the third connection request data (P41b), and executes processing of the second conference connection with the second conference client 22 (P43a, P43b). Due to this processing, a Web conference using a conference room that is identified by a port number included in the address information can be performed between the first conference client 21 and the second conference client 22. However, for example, a conference ID may be included in the third connection request data in addition to the address information. The virtual conference client 282 may execute processing of the second conference connection with the second conference client 22, thereby performing a Web conference using the conference room that is identified by the conference ID.

In the first to third ending sequences (see FIGS. 7 to 9), in response to receiving the second disconnection completion data (P61b), the virtual conference client manager 27 terminates the virtual conference client 282 (P65). However, for example, in the first ending sequence (see FIG. 7) and the third ending sequence (see FIG. 9), the first conference client 21 may transmit, to the conference server 26, termination request data that requests terminating the virtual conference client 282. The conference server 26 may transmit the termination request data transmitted from the first conference client 21 to the virtual conference client manager 27. Moreover, for example, in the second ending sequence (see FIG. 8), the second conference client 22 may transmit termination request data of the virtual conference client 282 to the virtual conference client 282. The virtual conference client 282 may transmit the termination request data transmitted from the second conference client 22 to the virtual conference client manager 27. The virtual conference client manager 27 may terminate the virtual conference client 282 in response to receiving the termination request data. In these cases, the conference client 20 can terminate the virtual conference client 28 when the second conference connection and the third conference connection are disconnected, and also can maintain the virtual conference client 28 when the second conference connection and the third conference connection are to be restarted.

What is claimed is:

1. A communication method comprising:
receiving, by a conference server, a plurality of first media data transmitted from a plurality of first conference clients by communication of a first method, the plurality of first conference clients being configured to perform a teleconference through the conference server by communication of the first method;
transmitting, by the conference server, the received plurality of first media data to a virtual conference client by communication of the first method;
receiving, by the virtual conference client, the plurality of first media data transmitted from the conference server, by communication of the first method;
mixing, by the virtual conference client, the received plurality of first media data to generate mixing data;
transmitting, by the virtual conference client, the generated mixing data to a second conference client by communication of a second method, the second conference client being configured to perform a teleconference by communication of the second method, the second method being different from the first method;
receiving, by the virtual conference client, second media data from the second conference client by communication of the second method;
transmitting, by the virtual conference client, the received second media data to the conference server by communication of the first method;
receiving, by the conference server, the second media data transmitted from the virtual conference client, by communication of the first method; and
transmitting, by the conference server, the received second media data to the plurality of first conference clients by communication of the first method.

2. The communication method according to claim 1, wherein the conference server receives the plurality of first media data encoded by a first codec from the plurality of first conference clients;
wherein the virtual conference client performs:
decoding the received plurality of first media data by the first codec;
mixing the decoded plurality of first media data to generate the mixing data; and
encoding the generated mixing data by a second codec; and
wherein the virtual conference client transmits the mixing data encoded by the second codec to the second conference client.

3. The communication method according to claim 1, wherein the virtual conference client receives the second media data encoded by a second codec from the second conference client;
wherein the virtual conference client decodes the received second media data by the second codec;
wherein the virtual conference client encodes the decoded second media data by a first codec without mixing with the plurality of first media data;
wherein the virtual conference client transmits the second media data encoded by the first codec to the conference server; and
wherein the conference server transmits the second media data encoded by the first codec to the plurality of first conference clients.

4. The communication method according to claim 1, wherein the virtual conference client receives first connection request data transmitted from a virtual conference client manager that starts up the virtual conference client, the first connection request data including address information of the second conference client;
wherein, in response to receiving the first connection request data, the virtual conference client transmits second connection request data to the second conference client identified by the address information, the second connection request data requesting connection between the virtual conference client and the second conference client;
wherein, in response to the transmitted second connection request data, the virtual conference client receives first connection completion data transmitted from the second conference client; and
wherein, in response to receiving the first connection completion data, the virtual conference client connects to the conference server.

5. The communication method according to claim 4, wherein the virtual conference client manager receives the first connection request data from the conference server;
wherein, in response to receiving the first connection request data, the virtual conference client manager starts up the virtual conference client; and
wherein the virtual conference client manager transmits the received first connection request data to the virtual conference client.

6. The communication method according to claim 1, wherein the virtual conference client receives third connection request data, the third connection request data transmitted from the second conference client, the third connection request data including address information of the virtual conference client, the third connection request data requesting connection with the virtual conference client; and
wherein, in response to receiving the third connection request data, the virtual conference client connects to the conference server.

7. The communication method according to claim 4, wherein, in response to receiving first disconnection request data from the conference server, the virtual conference client transmits second disconnection request data to the second conference client, the first disconnection request data being for requesting disconnection of connection between the first conference client and the second conference client;
wherein, in response to transmitting the second disconnection request data, the virtual conference client receives first disconnection completion data from the second conference client;
wherein, in response to receiving the first disconnection completion data, the virtual conference client disconnects connection with the conference server; and
wherein, after connection between the virtual conference client and the conference server is disconnected, the virtual conference client manager terminates the virtual conference client.

8. The communication method according to claim 7, wherein, in response to receiving the first disconnection completion data, the virtual conference client transmits second disconnection completion data to the virtual conference client manager; and
wherein, in response to receiving the second disconnection completion data, the virtual conference client manager terminates the virtual conference client.

9. The communication method according to claim 4, wherein the virtual conference client receives, from the second conference client, third disconnection request data for requesting disconnection of connection between the second conference client and the first conference client;
wherein, in response to receiving the third disconnection request data, the virtual conference client transmits second disconnection completion data to the virtual conference client manager;
wherein, in response to transmitting the second disconnection completion data, the virtual conference client disconnects connection with the conference server; and
wherein, in response to receiving the second disconnection completion data, the virtual conference client manager terminates the virtual conference client.

10. The communication method according to claim 5, wherein the virtual conference client manager receives, from the conference server, first connection request data including address information of each of a plurality of second conference clients; and
wherein, in response to receiving the first connection request data, the virtual conference client manager starts up a plurality of virtual conference clients corresponding to respective ones of the plurality of second conference clients.

11. The communication method according to claim 1, wherein each of the conference server and the virtual conference client is executed by an application executed in at least one physical server.

12. A communication system comprising a first server and a second server,
the first server comprising:
a first network interface;
a first hardware processor; and
a first memory storing instructions, the instructions, when executed by the first hardware processor, causing the first server to perform:
receiving a plurality of first media data through the first network interface, the plurality of first media data being transmitted from a plurality of first conference clients by communication of a first method, the plurality of first media data being encoded by a first codec, the plurality of first conference clients being configured to perform a teleconference through the first server by communication of the first method; and
transmitting the received plurality of first media data to the second server through the first network interface by communication of the first method,
the second server being physically different from the first server, the second server comprising:
a second network interface;
a second hardware processor; and
a second memory storing instructions, the instructions, when executed by the second hardware processor, causing the second server to perform:
receiving the plurality of first media data transmitted from the first server, through the second network interface, by communication of the first method;
decoding the received plurality of first media data by the first codec;
mixing the decoded plurality of first media data to generate mixing data;
encoding the generated mixing data by a second codec;
transmitting the mixing data encoded by the second codec, to a second conference client, through the second network interface by communication of a second method, the second conference client being configured to perform a teleconference by communication of a second method, the second method being different from the first method;
receiving second media data encoded by the second codec, from the second conference client, through the second network interface by communication of the second method;
decoding the received second media data by the second codec;
encoding the decoded second media data by the first codec without mixing with the plurality of first media data; and
transmitting the second media data encoded by the first codec, to the first server, through the second network interface by communication of the first method,
wherein the first server is configured to perform:
receiving the second media data transmitted from the second server, through the first network interface, by communication of the first method; and
transmitting the received second media data to the plurality of first conference clients through the first network interface by communication of the first method.

13. A non-transitory computer-readable storage medium storing a communication program, the communication program being executable on a computer of a server, the communication program causing, when executed, the server to perform operations comprising:
an operation of, when a conference server receives, by communication of a first method, a plurality of first media data that is transmitted from a plurality of first conference clients by communication of the first method and that is encoded by a first codec and the conference server transmits the received plurality of first media data by communication of the first method, receiving the plurality of first media data from the conference server by communication of the first method, the plurality of first conference clients being configured to perform a teleconference through the conference server by communication of the first method;
an operation of decoding the received plurality of first media data by the first codec;
an operation of mixing the decoded plurality of first media data to generate mixing data;
an operation of encoding the generated mixing data by a second codec;
an operation of transmitting the mixing data encoded by the second codec, to a second conference client, by communication of a second method, the second conference client being configured to perform communication of the second method, the second method being different from the first method;
an operation of receiving second media data encoded by the second codec, from the second conference client, by communication of the second method;
an operation of decoding the received second media data by the second codec;
an operation of encoding the decoded second media data by the first codec without mixing with the plurality of first media data; and
an operation of transmitting the second media data encoded by the first codec, to the conference server, by communication of the first method.
